(19) United States
(12) Patent Application Publication
(10) Pub. No.: US 2010/0149379 A1
(43) Pub. Date: Jun. 17, 2010

(54) IMAGE SENSOR WITH THREE-DIMENSIONAL INTERCONNECT AND CCD

(76) Inventors: Joseph R. Summa, Hilton, NY (US); John P. McCarten, Penfield, NY (US)

Correspondence Address: Pedro P. Hernandez;Patent Legal Staff, Eastman Kodak Company, 343 State Street, Rochester, NY, 14650-2201, US

(21) Appl. No.: 12/616,208

(22) Filed: Nov. 11, 2009

Related U.S. Application Data
(60) Provisional application No. 61/122,860, filed on Dec. 16, 2008.

(51) Int. Cl. H04N 5/76; H04N 5/335

(52) U.S. Cl. 348/231.99; 348/311; 348/E05.091; 348/E05.031

(57) ABSTRACT

An image sensor and associated image capture device and method include a sensing wafer with a plurality of charge storage elements. One or more floating diffusions are associated with the plurality of charge storage elements, and charge is transferred among the charge storage elements to the one or more floating diffusions. The one or more floating diffusions on the sensing wafer are electrically connected to support circuitry on a circuit wafer.

### CROSS REFERENCE TO RELATED APPLICATION

This application claims the benefit of U.S. Provisional Application No. 61/122,860 filed on Dec. 16, 2008, which is incorporated herein by reference.

### TECHNICAL FIELD

The invention relates generally to the field of image sensors, and more particularly to a stacked image sensor construction.

### BACKGROUND

A typical image sensor has an image sensing portion that includes a photosensitive area or charge collection area for collecting a charge in response to incident light and a transfer gate for transferring charge from the photosensitive area to a transfer mechanism. Usually, the sensing portion is fabricated within the same material layer and with similar processes as the control circuitry for the image sensor. In an effort to increase the number of pixels provided in an image sensor, pixel size has been decreasing. However, as the pixel size shrinks, the illuminated area of the photodetector is also typically reduced, in turn decreasing the captured signal level and degrading performance.

Stacked image sensor structures are known that consist of a sensor-only wafer over one (or more) circuit wafers. A stacked structure such as this requires electrical interconnects between the wafers to be able to operate the sensor as well as read out the collected charges. The interconnects require the use of areas on the sensor and circuit wafers that could otherwise be used for charge collection and storage or support circuitry. Some interconnects also have the potential to cause noise in adjacent pixels.

Thus, a need exists for an improved stacked image sensor structure.

### SUMMARY

An image sensor and associated image capture device and method include a sensing wafer with a plurality of charge storage elements. A floating diffusion is associated with the plurality of charge storage elements, and a charge is transferred among the charge storage elements to the floating diffusion. The floating diffusion is electrically connected to support circuitry of a circuit wafer.

The present invention thus provides the advantage of an improved image sensor structure.

### BRIEF DESCRIPTION OF THE DRAWINGS

FIG. 1 is a block diagram illustrating an embodiment of an image capture device;

FIG. 2 is a perspective view conceptually illustrating an embodiment of image sensor;

FIG. 3 is a section view conceptually illustrating aspects of the embodiment of the image sensor illustrated in FIG. 2;

FIG. 4 is a block diagram conceptually illustrating further aspects of embodiments of the disclosed image sensor'

FIG. 5 is a top view conceptually illustrating an array of charge storage elements in accordance with disclosed embodiments;

FIG. 6 is a block diagram conceptually illustrating an embodiment of a front illuminated image sensor; and

FIG. 7 schematically illustrates portions of an embodiment of a sensing wafer of an image sensor.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

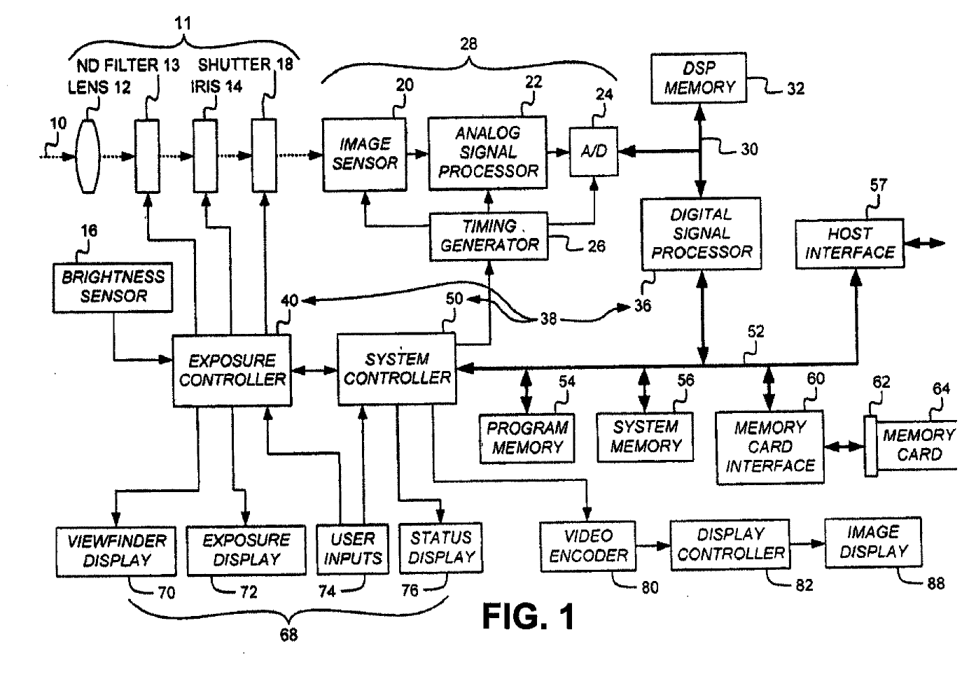

Turning now to FIG. 1, a block diagram of an image capture device shown as a digital camera embodying aspects of the present disclosure is illustrated. Although a digital camera is illustrated and described, the present invention is clearly applicable to other types of image capture devices. In the disclosed camera, light 10 from a subject scene is input to an imaging stage 11, where the light is focused by a lens 12 to form an image on an image sensor 20. The image sensor 20 converts the incident light to an electrical signal for each picture element (pixel).

The amount of light reaching the sensor 20 is regulated by an iris block 14 that varies the aperture and the neutral density (ND) filter block 13 that includes one or more ND filters interposed in the optical path. Also regulating the overall light level is the time that the shutter block 18 is open. The exposure controller block 40 responds to the amount of light available in the scene as metered by the brightness sensor block 16 and controls all three of these regulating functions.

This description of a particular camera configuration will be familiar to one skilled in the art, and it will be apparent to such a skilled person that many variations and additional features are present. For example, an autofocus system is added, or the lens is detachable and interchangeable. It will be understood that the present disclosure applies to various types of digital cameras where similar functionality is provided by alternative components. For example, the digital camera is a relatively simple point and shoot digital camera, where the shutter 18 is a relatively simple movable blade shutter, or the like, instead of the more complicated focal plane arrangement. Aspects of the present invention can also be practiced on imaging components included in non-camera devices such as mobile phones and automotive vehicles.

An analog signal from the image sensor 20 is processed by an analog signal processor 22 and applied to an analog to digital (A/D) converter 24. A timing generator 26 produces various clocking signals to select rows and pixels and synchronizes the operation of the analog signal processor 22 and the A/D converter 24. The image sensor stage 28 includes the image sensor 20, the analog signal processor 22, the A/D converter 24, and the timing generator 26. The components of the image sensor stage 28 can be separately fabricated integrated circuits, or they could be fabricated as a single integrated circuit as is commonly done with CMOS image sensors. The resulting stream of digital pixel values from the A/D converter 24 is stored in a memory 32 associated with the digital signal processor (DSP) 36.

The digital signal processor 36 is one of three processors or controllers in the illustrated embodiment, in addition to a system controller 50 and an exposure controller 40. Although this partitioning of camera functional control among multiple controllers and processors is typical, these controllers or processors are combined in various ways without affecting the functional operation of the camera and the application of the present invention. These controllers or processors can comprise one or more digital signal processor devices, microcontrollers, programmable logic devices, or other digital logic circuits. Although a combination of such controllers or processors has been described, it should be apparent that one controller or processor can be designated to perform all of the needed functions. All of these variations can perform the same function and fall within the scope of this invention, and the term “processing stage” will be used as needed to encompass all of this functionality within one phrase, for example, as in processing stage 38 in FIG. 1.

In the illustrated embodiment, the DSP 36 manipulates the digital image data in its memory 32 according to a software program permanently stored in program memory 54 and copied to the memory 32 for execution during image capture. The DSP 36 executes the software necessary for practicing image processing. The memory 32 includes of any type of random access memory, such as SDRAM. A bus 30 comprising a pathway for address and data signals connects the DSP 36 to its related memory 32, A/D converter 24 and other related devices.

The system controller 50 controls the overall operation of the camera based on a software program stored in the program memory 54, which can include Flash EEPROM or other nonvolatile memory. This memory can also be used to store image sensor calibration data, user setting selections and other data which must be preserved when the camera is turned off. The system controller 50 controls the sequence of image capture by directing the exposure controller 40 to operate the lens 12, ND filter 13, iris 14, and shutter 18 as previously described, directing the timing generator 26 to operate the image sensor 20 and associated elements, and directing the DSP 36 to process the captured image data. After an image is captured and processed, the final image file stored in memory 32 is transferred to a host computer via an interface 57, stored on a removable memory card 64 or other storage device, and displayed for the user on an image display 88.

A bus 52 includes a pathway for address, data and control signals, and connects the system controller 50 to the DSP 36, program memory 54, system memory 56, host interface 57, memory card interface 60 and other related devices. The host interface 57 provides a high speed connection to a personal computer (PC) or other host computer for transfer of image data for display, storage, manipulation or printing. This interface is an IEEE1394 or USB2.0 serial interface or any other suitable digital interface. The memory card 64 is typically a Compact Flash (CF) card inserted into a socket 62 and connected to the system controller 50 via a memory card interface 60. Other types of storage that are utilized include, for example, PC-Cards, MultiMedia Cards (MMC), or Secure Digital (SD) cards.

Processed images are copied to a display buffer in the system memory 56 and continuously read out via a video encoder 80 to produce a video signal. This signal is output directly from the camera for display on an external monitor, or processed by the display controller 82 and presented on an image display 88. This display is typically an active matrix color liquid crystal display (LCD), although other types of displays are used as well.

The user interface, including all or any combination of viewfinder display 70, exposure display 72, status display 76 and image display 88, and user inputs 74, is controlled by a combination of software programs executed on the exposure controller 40 and the system controller 50. User inputs 74 typically include some combination of buttons, rocker switches, joysticks, rotary dials or touchscreens. The exposure controller 40 operates light metering, exposure mode, autofocus and other exposure functions. The system controller 50 manages the graphical user interface (GUI) presented on one or more of the displays, for example, on the image display 88. The GUI typically includes menus for making various option selections and review modes for examining captured images.

The exposure controller 40 accepts user inputs selecting exposure mode, lens aperture, exposure time (shutter speed), and exposure index or ISO speed rating and directs the lens and shutter accordingly for subsequent captures. The brightness sensor 16 is employed to measure the brightness of the scene and provide an exposure meter function for the user to refer to when manually setting the ISO speed rating, aperture and shutter speed. In this case, as the user changes one or more settings, the light meter indicator presented on viewfinder display 70 tells the user to what degree the image will be over or underexposed. In an automatic exposure mode, the user changes one setting and the exposure controller 40 automatically alters another setting to maintain correct exposure.

For example, for a given ISO speed rating when the user reduces the lens aperture, the exposure controller 40 automatically increases the exposure time to maintain the same overall exposure.

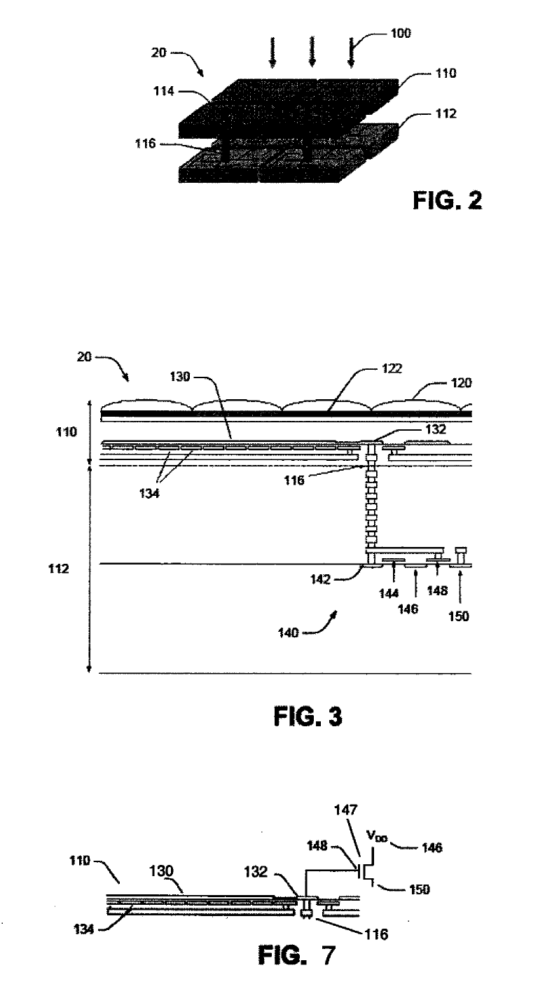

FIG. 2 conceptually illustrates an embodiment of the image sensor 20. The image sensor 20 includes a sensing wafer 110 and a circuit wafer 112. The sensing wafer 110 has an array of pixels 114 that collect charges in response to incident light 100. The charges are sensed by the circuit wafer 112 by wafer interconnections 116. The circuit wafer 112 has support circuitry, including circuitry to read-out the charges collected by the pixels 114. With known stacked image sensor structures, the wafer interconnections require the use of areas on the sensor and circuit wafers that could otherwise be used for charge collection and storage or support circuitry. Some interconnects also have the potential to cause noise in adjacent pixels. It is thus desirable to minimize the number of interconnects.

Embodiments of the disclosed image sensor 20 incorporate a charge transfer element into the sensor wafer that enables charge to be moved across several pixels to an interconnect node 116 that need not be immediately adjacent to the charge collection point. This reduces the number of interconnects 116 required, preserving wafer area for other uses.

FIG. 3 is a cross-section view conceptually illustrating further aspects of an embodiment of the image sensor 20. A micro lens 120 and a color filter array (CFA) 122 are situated over the sensing wafer 110. The pixels 114 include a plurality of charge transfer elements 130 and a floating diffusion 132 associated with the charge storage elements 130. The charge storage elements 130 illustrated in the embodiment shown in FIG. 3 are charge coupled devices (CCD), which are operatively coupled to a photodetector, such as a photodiode, that collects a charge in response to received light. FIG. 4 conceptually illustrates a photodiode 136 coupled to a CCD 130.

In another embodiment in accordance with the invention, the charge storage elements 130 are CCDs, with one or more of the CCDs configured as light-sensitive CCDs. The light-sensitive CCDs collect charge in response to received light.

A CCD array is typically composed of an array of closely spaced gates 134 that are used to effect transfer of charge in the CCD. The illustrated embodiment uses micro gaps between a single polycrystalline silicon (polysilicon) level to allow multiple adjacent gates on the same poly level. A charge is transferred among the charge storage elements 130 to the floating diffusion 132, which is electrically connected to support circuitry 140 of the circuit wafer 112. In some embodiments, the support circuitry 140 includes a floating diffusion 142 that is electrically connected to the floating diffusion 132 on the sensing wafer 112 by the interconnects 116. In addition to the floating diffusion 142, the support circuitry can include, for example, a reset transistor connected to the floating diffusion 142, with the reset transistor including a reset gate 144, a V_{DD} voltage supply 146, and a source follower transistor coupled to V_{DD} and having input and output terminals 148, 150. In other embodiments, an input to the source follower transistor is coupled to the floating diffusion 132 on the sensing wafer 110, allowing an amplified signal to be transferred to the circuit wafer 112. FIG. 7 conceptually illustrates portions of the sensing wafer 110 including a source follower transistor 147 coupled to V_{DD} 146 with the source follower input 148 coupled to the floating diffusion 132 and the source follower output 150 coupled to the support circuitry on the circuit wafer 112 (not shown).

In the illustrated embodiments, the charge storage elements 130 are arranged in an array of rows and columns. FIG. 5 illustrates an example of the array 160 of storage elements 130. The charge storage elements 130 are grouped into subsets 162 within each row with a respective floating diffusion 132 associated with each subset 162. Thus, the floating diffusions 132 in the sensing wafer 110 each substitute for, or take the place of, one of the charge storage elements 130 in an embodiment in accordance with the invention. In another embodiment in accordance with the invention, each floating diffusion 132 substitutes for a portion of one charge storage element 130. A charge 164 is transferred horizontally to a respective floating diffusion node 132. Charge 164 can be transferred in either direction as illustrated in FIG. 5.

In yet another embodiment in accordance with the invention, the charge storage elements 130 are arranged in an array of rows and columns and the floating diffusions 132 are all disposed in one column at the edge or border of the array or within the array. Each row of charge storage elements has a floating diffusion associated with the entire row. Charge is transferred among the charge storage elements in each row to the floating diffusion associated with the entire row.

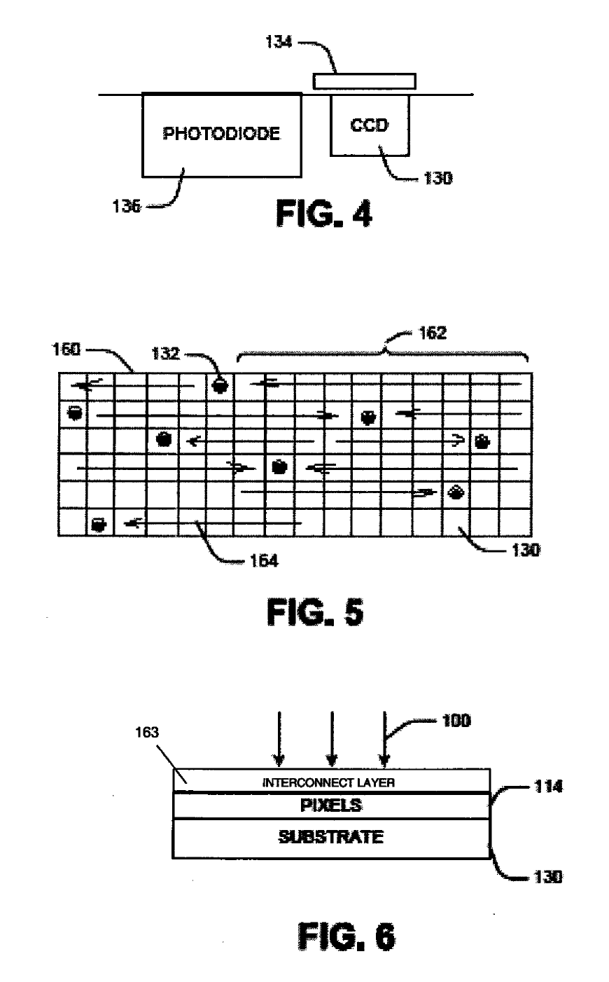

In some embodiments, such as the embodiment illustrated in FIG. 3, the sensing wafer 110 is a back side illuminated sensor, where exposed light is projected towards the back side surface of the sensing wafer 110. The photodetectors or light sensitive CCDs of the pixels 114 are located on a front side of the sensing wafer, which is thin enough so that light projected towards the backside of the substrate can reach the pixels. In other embodiments, the sensing wafer 110 is a front side illuminated sensor, where light is projected towards the front side surface of the wafer. FIG. 6 conceptually illustrates a front side illuminated sensor 110, in which light 100 is projected through the associated metal and interconnect layers 163 towards the photodetectors or light sensitive CCDs in the pixels 114. The pixels are located above the substrate 164.

The invention has been described in detail with particular reference to certain preferred embodiments thereof, but it will be understood that variations and modifications can be effected within the spirit and scope of the invention. Additionally, even though specific embodiments of the invention have been described herein, it should be noted that the application is not limited to these embodiments. In particular, any features described with respect to one embodiment may also be used in other embodiments, where compatible. And the features of the different embodiments may be exchanged, where compatible.

### PARTS LIST

10 light
11 imaging stage
12 lens
13 ND filter block
14 iris block
16 brightness sensor block
18 shutter block
20 image sensor
22 analog signal processor
24 analog to digital (A/D) converter
26 timing generator
28 image sensor stage
30 bus
32 memory
36 digital signal processor (DSP)
38 processing stage
40 exposure controller
50 system controller
52 bus
54 program memory
56 system memory
57 host interface
60 memory card interface
62 socket
64 memory card
70 viewfinder display
72 exposure display
74 user inputs
76 status display
80 video encoder
82 display controller
88 image display
100 light
110 sensing wafer
112 circuit wafer
114 pixels
116 wafer interconnections
120 lens
122 color filter array
130 charge transfer elements/CCD
132 floating diffusion
134 CCD gates
136 photodiode
140 support circuitry
142 floating diffusion
144 reset gate
146 VDD
147 source follower transistor
148 source follower input
150 source follower output
160 array
162 array subsets
163 metal and interconnect layers
164 substrate

1. An image sensor, comprising:
a sensing wafer including a plurality of charge storage elements and one or more floating diffusions associated with the plurality of charge storage elements, wherein charge is transferred among the charge storage elements to the one or more floating diffusions; and
a circuit wafer including support circuitry for the sensing wafer, wherein the one or more floating diffusions are electrically connected to the support circuitry.

2. The image sensor of claim 1, wherein the support circuitry includes one or more floating diffusions that each are electrically connected to respective floating diffusions on the sensing wafer.

3. The image sensor of claim 2, wherein the support circuitry includes a reset gate coupled to at least one floating diffusion, a voltage supply, and a source follower transistor.

4. The image sensor of claim 1, further comprising a source follower transistor coupled to at least one floating diffusion on the sensing wafer.

5. The image sensor of claim 1, wherein the charge storage elements are arranged in an array of rows and columns, and wherein the charge storage elements are grouped into subsets within each row with a respective floating diffusion associated with each subset.

6. The image sensor of claim 1, wherein at least one floating diffusion substitutes for a charge storage element on the sensing wafer.

7. The image sensor of claim 1, wherein each charge storage element comprises a charge coupled device.

8. The image sensor of claim 7, wherein the charge coupled device is operatively connected to a photodetector.

9. The image sensor of claim 1, wherein the sensing wafer comprises a back-side illuminated sensing wafer.

10. The image sensor of claim 1, wherein the sensing wafer comprises a front-side illuminated image sensor.

11. An image capture device, comprising:
an imaging stage configured to receive light forming an image;
an image sensor receiving light from the imaging stage, the image sensor including:
a sensing wafer including a plurality of charge storage elements and one or more floating diffusions associated with the plurality of charge storage elements, wherein charge is transferred among the charge storage elements to the one or more floating diffusions; and
a circuit wafer including support circuitry for the sensing wafer, wherein each floating diffusion on the sensing wafer is electrically connected to the support circuitry; and
a memory configured to store the received image.

12. The image capture device of claim 11, wherein the support circuitry includes one or more floating diffusions that are each electrically connected to respective floating diffusions on the sensing wafer.

13. The image capture device of claim 11, wherein the charge storage elements are arranged in an array of rows and columns, and wherein the charge storage elements are grouped into subsets within each row with a respective floating diffusion associated with each subset.

14. The image capture device of claim 11, wherein at least one floating diffusion on the sensing wafer substitutes for a charge storage element.

15. The image capture device of claim 11, wherein each charge storage element comprises a charge coupled device.

16. An image sensing method, comprising:
collecting a charge in response to received light;
transferring the charge among a plurality of charge storage elements to one or more floating diffusions on a sensor wafer; and
sensing the charge using support circuitry on a circuit wafer electrically connected to the sensing wafer.

17. The method of claim 16, wherein sensing the charge using support circuitry includes sensing the charge on the one or more floating diffusions on the sensing wafer using respective floating diffusions on the circuit wafer.

18. The method of claim 16, wherein the charge storage elements are arranged in an array of rows and columns and the charge storage elements are grouped into subsets within each row with a respective floating diffusion associated with each subset, and wherein transferring the charge among the plurality of charge storage elements includes transferring the charge in either a first or second direction within the rows.

19. The method of claim 16, wherein the light is received by a back-side of the sensing wafer.

20. The method of claim 16, wherein the light is received by a front-side of the sensing wafer.
